(19) United States
(12) Patent Application Publication
(10) Pub. No.: US 2005/0002061 A1
(43) Pub. Date: Jan. 6, 2005

(54) Print job creation apparatus and print job creation method

(76) Inventors: Yasuhiko Uchida, Nagano-ken (JP); Hiroyasu Tamagawa, Nagano-ken (JP); Satoru Momose, Nagano-ken (JP); Kazunori Shimoda, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/828,878

(22) Filed: Apr. 20, 2004

(30) Foreign Application Priority Data
Apr. 25, 2003 (JP) 2003-122397

(51) Int. Cl. G06F 15/00

(52) U.S. Cl. 358/1.18; 358/1.12

(57) ABSTRACT

A print job creation apparatus of the invention sets a priority order of image integration areas in a selected template for integration of images, when the selected template is displayed in a layout editing field 93. When the user selects desired images among multiple images displayed in an image display filed 96a and clicks a ‘Place’ button 94a, the print job creation apparatus integrates the selected images in their alignment order into the image integration areas of the template in the preset priority order. When the user selects one image integration area and a desired image among the images displayed in the image display field 96a and clicks a ‘Replace’ button 94b, an image currently placed in the selected image integration area is replaced with the selected image.

### BACKGROUND OF THE INVENTION

1. Field of the Invention

The present invention relates to a print job creation apparatus and a corresponding print job creation method. More specifically the invention pertains to a print job creation apparatus that creates a print job, which includes layout of at least one image in a template having at least one image integration area to integrate an image therein, as well as to a corresponding print job creation method.

2. Description of the Prior Art

A proposed print job creation apparatus functions to read picture images taken with a digital camera, introduce simple modifications of the images, incorporate the images in a style, such as a postcard or an album, and set printing conditions. This prior art apparatus reads photographs, classifies the photographs into desired categories to be stored like films, and creates print jobs. The print job creation process includes a film selection step, a print service selection step of selecting a desired print service, for example, postcard printing, album printing, or calendar printing, a photograph selection step of selecting photographs to be printed, a print setting step of specifying settings of a style, a print option, and a printer, a layout adjustment step of adjusting a layout of pages with photographs incorporated therein, and a print step of finely adjusting the printing position, inputting the number of copies, and giving a print execution instruction. In some print services like album printing, multiple images are generally printed on one identical printing sheet. The user selects desired images as objects to be printed and a desired style among available style options to arrange the selected desired images therein. The selected images are then sequentially arranged in their alignment order into image frames of the selected style (see ‘Digital Camera de!! Doji Print (Simultaneous Printing with Digital Camera) 6, User's Manual, 1^{st} ed. A. I. Soft. Inc., July 2002, p 110-115).

The prior art print job creation apparatus allows images to be placed in a preset order in a predetermined style but is not directed to print with a template, which has multiple image integration areas to integrate images as a background. There is a proposed printing technique that sets transparent areas for front images and thereby enables a back image to be displayed. This technique, however, requires the user a number of time-consuming and labor-consuming operations to specify the layout of the back image and the front images and set the transparent images for the front images.

### SUMMARY OF THE INVENTION

The present invention aims to facilitate selection of a desired template and integration of desired images into the selected template in a print job creation apparatus and a corresponding print job creation method. The invention also aims to facilitate replacement of an image currently placed in a template with an arbitrary image in the print job creation apparatus and the corresponding print job creation method.

At least part of the above and other related objects is attained by the following configuration of a print job creation apparatus and a corresponding print job creation method of the invention.

A print job creation apparatus of the invention creates a print job, which includes layout of at least one image in a template having at least one image integration area to integrate an image therein. The print job creation apparatus includes a template selection module that selects a template in response to a user's template selection instruction; a priority order setting module that sets a priority order of at least one image integration area included in the selected template, based on an arrangement of the at least one image integration area; a built-in image selection module that selects at least one image as a built-in image to be integrated into the selected template, in response to the user's image selection instruction; and an image integration module that integrates the at least one selected built-in image into the at least one image integration area of the selected template in the priority order set by the priority order setting module, in response to the user's image integration instruction.

The print job creation apparatus of the invention integrates selected images into image integration areas of a selected template in the preset priority order. This arrangement desirably facilitates integration of desired images into a desired template.

In the print job creation apparatus of the invention, the priority order setting module may set the priority order of the at least one image integration area according to a positional sequence of an upper end of each image integration area in the selected template. In addition, the priority order setting module may set the priority order of the at least one image integration area according to a positional sequence of a left end of each image integration area in the selected template. In the print job creation apparatus of the invention, the template may be prepared by setting at least one transparent area as the image integration area in an original template image, which has no image integration area, and the priority order setting module may set the priority order of the at least one image integration area, based on an arrangement of the at least one transparent area in the original template image. Further, in the print job creation apparatus of the invention, the template may be prepared by combining an original template image, which has no image integration area, with at least one area display image, which defines the at least one image integration area, and the priority order setting module may set the priority order of the at least one image integration area, based on the at least one area display image. In this case, the area display image may be used to set a transparent area corresponding to the image integration area in the original template image and the area display image may be a one-pixel-one-bit image having one-bit information for each one pixel, which represents either a bit-on or a bit-off to show inclusion into or exclusion from an image integration area.

The print job creation apparatus of the invention may further include: an image replacement module that, in response to the user's selection of one image integration area in the template with a built-in image currently placed therein by the image integration module and an image to be newly integrated into the selected image integration area, replaces the built-in image currently placed in the selected image integration area with the selected image. In addition, the print job creation apparatus of the invention may include: a print service selection module that selects one print service among multiple print service options, in response to the user's operation; and a template storage module that stores available templates corresponding to each of the multiple print service options, and the template selection module may display a list of available templates corresponding to a print service selected by the print service selection module, among all the templates stored in the template storage module, to allow selection of a desired template. In this case, the multiple print services may include at least one of an enlargement printing service, a digest printing service, a calendar printing service, a postcard printing service, a photo name card printing service, an ID photograph printing service, a seal printing service, a label printing service, and an album printing service.

The technique of the invention is not restricted to these applications of the print job creation apparatus discussed above, but is also actualized as a print job creation method that creates a print job with the print job creation apparatus having any of the above arrangements.

### BRIEF DESCRIPTION OF THE DRAWINGS

FIG. 1 schematically illustrates the configuration of a printing system 10 including a print job creation apparatus 20 in one embodiment of the invention;

FIG. 2 shows an example of menu window 60;

FIG. 3 is a flowchart showing a print job creation routine;

FIG. 4 shows an example of image registration window 70;

FIG. 5 shows an example of template selection window 80;

FIG. 6 shows an example of layout editing window 90;

FIG. 7 is a flowchart showing a priority order setting routine;

FIG. 8 shows a process of preparing a template image;

FIG. 9 shows a process of integrating images into image integration areas;

FIG. 10 shows the process of integrating the images in the image integration areas;

FIG. 11 is a flowchart showing an image integration routine;

FIG. 12 shows a process of replacement of a built-in image;

FIG. 13 shows the process of replacement of the built-in image; and

FIG. 14 shows an example of print window 100.

### DESCRIPTION OF THE PREFERRED EMBODIMENTS

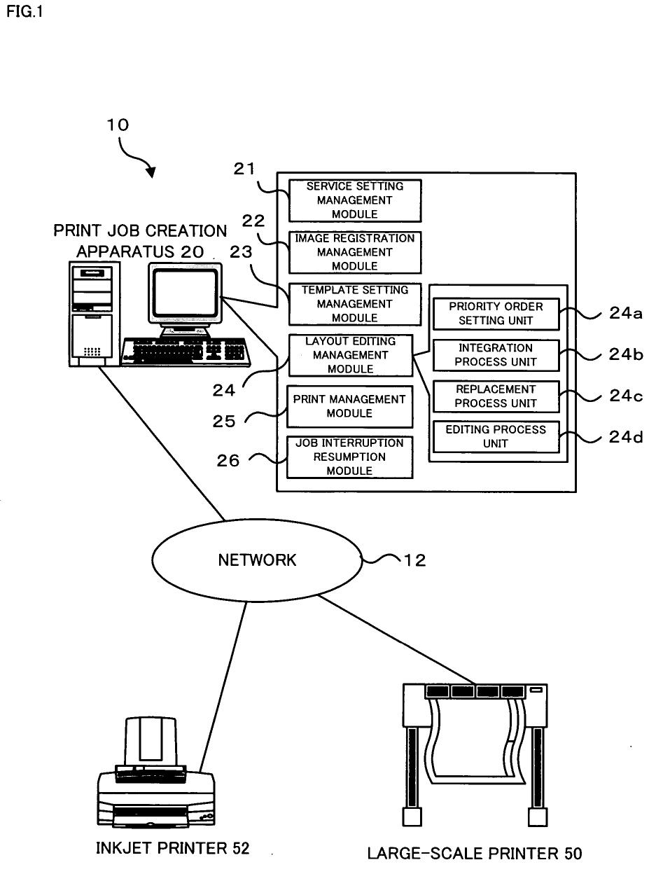

A preferred embodiment of the invention is discussed below. FIG. 1 schematically illustrates the configuration of a printing system 10 including a print job creation apparatus 20 in one embodiment of the invention. The printing system 10 of the embodiment includes the print job creation apparatus 20 to create print jobs, a large-scale printer 50, and an inkjet printer 52, which are connected via a network 12.

The print job creation apparatus 20 is constructed as a general computer, in which a non-illustrated print job creation program as application software and support data including template images used for printing are installed. Execution of the print job creation program causes the computer to function as the print job creation apparatus. The print job creation apparatus 20 creates print jobs as various print services including creation of calendars and creation of postcards and gives instructions of executing such print jobs. As shown in FIG. 1, the print job creation apparatus 20 has, as its functional blocks, a service setting management module 21 that accepts settings of a service selected among various print services to create a print job, an image registration management module 22 that manages registration of one or multiple images used for each print job, a template setting management module 23 that manages settings of a template used for each print job, a layout editing management module 24 that manages adjustment of a layout of images and editing of images, a print management module 25 that manages printing, and a job interruption resumption module 26 that interrupts creation of a print job in the middle or resumes creation of a print job, which has been interrupted in the middle of its creation (hereafter referred to as print job under creation). The layout editing management module 24 of the print job creation apparatus 20 has a priority order setting unit 24a that sets a priority order of image integration areas included in a template for integration of selected images, an integration process unit 24b that integrates selected images into image integration areas, a replacement process unit 24c that replaces an image currently placed in a template with another image, and an editing process unit 24d that retouches each built-in image. The print job creation apparatus 20 of the embodiment also has a job output management module that manages output of each print job under creation, a job input management module that manages input of each print job under creation, and a job duplication module that duplicates a print job under creation or an executed print job to create a new print job. These modules are, however, not essential for the present invention and are thus neither illustrated nor described in detail.

The large-scale printer 50 is capable of high-quality color printing to a size A1, while the inkjet printer 52 is capable of high-quality color printing to a size A4. Due to limitations of space, there are only two printers, that is, the large-scale printer 50 and the inkjet printer 52, connected to the network 12 in the illustration of FIG. 1. In the actual state, however, three or more printers of an identical type or different types may be connected to the network 12.

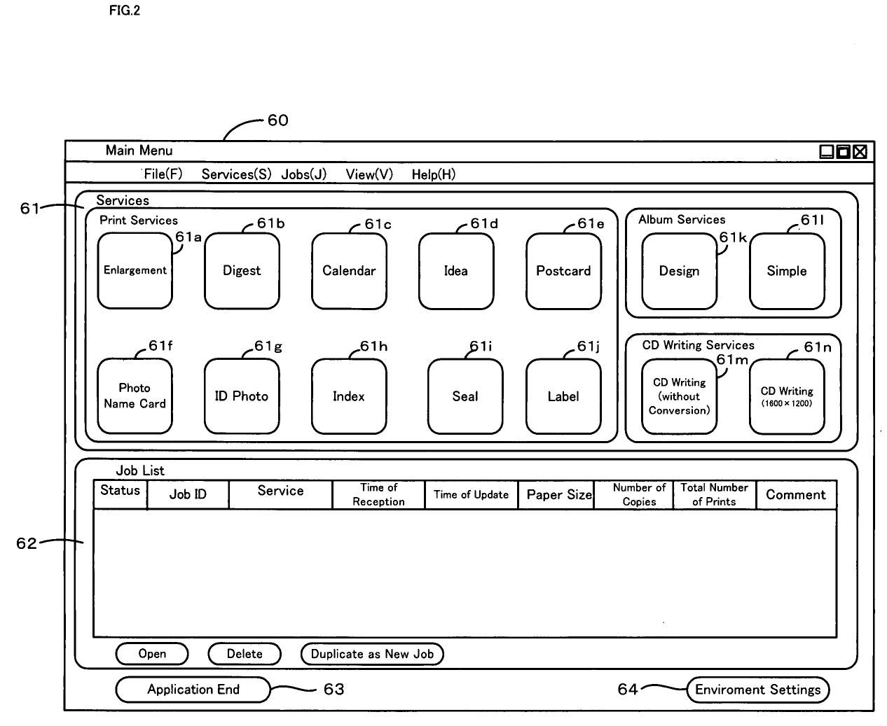

The following describes the operations of the print job creation apparatus 20 of the embodiment constructed as discussed above. FIG. 2 shows an example of menu window 60 open on the display of the print job creation apparatus 20 on startup of the non-illustrated print job creation program as the application software. The menu window 60 of FIG. 2 has a service selection field 61 for selecting a desired print service and a job list field 62 for displaying a list of print jobs. The service selection field 61 includes various selection buttons for print services, album services, and CD writing services. The buttons for print services include an ‘Enlargement’ button 61a to print an image in a large size, a ‘Digest’ button 61b to print multiple images as a digest, a ‘Calendar’ button 61c to print a calendar with images, an ‘Idea’ button 61d to print an image with any of templates of various designs, a ‘Postcard’ button 61e to print an image on a postcard, a ‘Photo Name Card’ button 61f to print name cards with a photograph, an ‘ID Photo’ button 61g to print an ID photograph, an ‘Index’ button 61h to print an index of a large number of images, a ‘Seal’ button 61i to create seals, labels, or stickers with an image, and a ‘Label’ button 61j to create labels for CDs and DVDs. The buttons for album services include a ‘Design’ button 61k to create an album with any of templates of various designs and a ‘Simple’ button 61l to create an album with a simple template. The buttons for CD writing services include a ‘CD Writing (without Conversion)’ button 61m to write an image into a CD without any conversion and a ‘CD Writing (1600×1200)’ button 61n to alter the size of an image to 1600×1200 and write the image of the altered size into a CD. The status, the job ID, the selected service, the time of reception, the time of update, the paper size, the number of copies, the total number of prints, and the comment with regard to respective print jobs under creation are listed in the job list field 62. The print job under creation and the display in the job list field 62 will be discussed later. The menu window 60 also has an ‘Application End’ button 63 and an ‘Environment Settings’ button 64 located below the job list field 62.

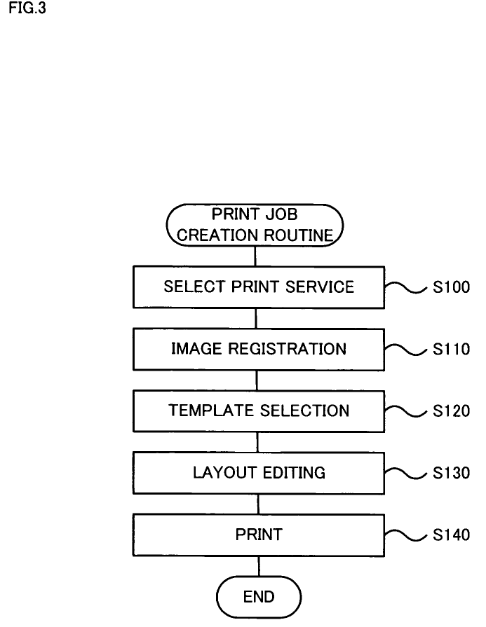

The print job creation apparatus 20 of the embodiment creates a print job according to a print job creation routine shown in the flowchart of FIG. 3. The print job creation routine first receives selection of a desired print service (step S100). The user clicks one of the available service buttons 61a through 61n in the service selection field 61 of the menu window 60 shown in FIG. 2 to select a desired print service. The service setting management module 21 of the print job creation apparatus 20 manages display of the menu window 60, acceptance of selection of a service, and start of creation of a print job in the selected service.

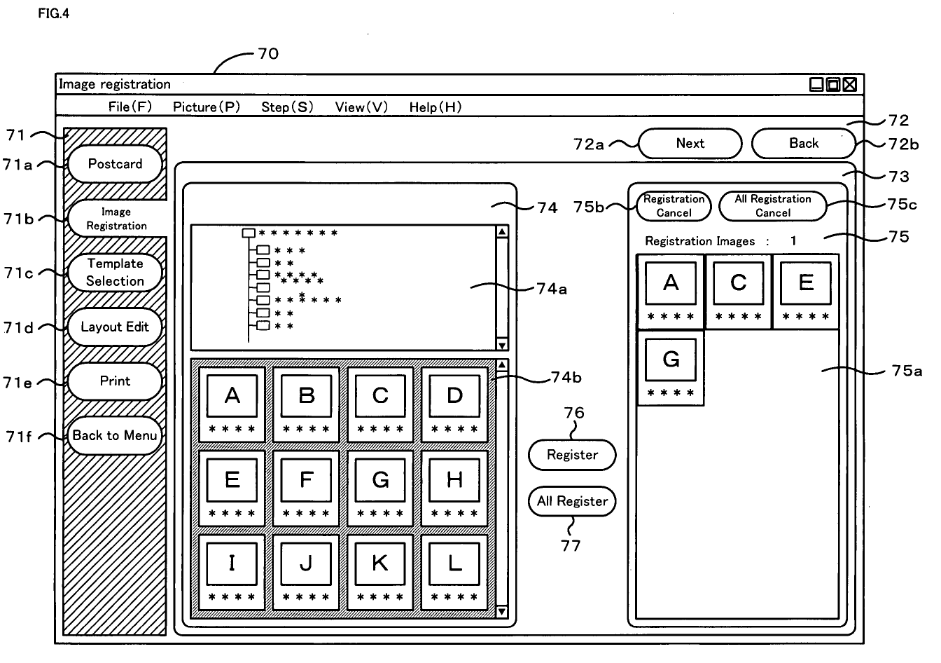

In response to selection of a desired print service, the print job creation apparatus 20 of the embodiment opens an image registration window 70 shown in FIG. 4 and executes an image registration step to register images used for the selected print service (step S110). In the illustrated example of FIG. 4, the image registration window 70 has a process display field 71 to display a print job creation process and an image registration dialog box 72 to register selected images. The process display field 71 includes a ‘Selected Service Display’ button 71a to display a selected print service, an ‘Image Registration’ button 71b, a ‘Template Selection’ button 71c, a ‘Layout Edit’ button 71d, and a ‘Print’ button 71e showing steps in the print job creation process, and a ‘Back to Menu’ button 71f to interrupt creation of a current print job and go back to the menu window 60. The image registration dialog box 72 is displayed in connection with the ‘Image Registration’ button 71b and is open when the print job creation process is at the image registration-step.

The image registration dialog box 72 has a work field 73, which includes an image selection field 74 to receive the user's selection of a storage place (a directory or a folder), in which images are stored, and display a list of thumbnails and file names of images stored in the selected storage place and a registered image display field 75 to display a list of thumbnails and file names of registered images. The work field 73 also has a ‘Register’ button 76 to register an image selected in the image selection field 74 and display the registered image in the registered image display field 75 and an ‘All Register’ button 77 to register all the images displayed in the image selection field 74 and display all the registered images in the registered image display field 75. The user selects a desired image storage place in a storage place display field 74a of the image selection field 74, selects a desired image among images displayed in an image display field 74b of the image selection field 74 in response to selection of the storage place (that is, among images stored in the selected storage place), and clicks the ‘Register’ button 76. The desired image is accordingly registered and displayed in an image display field 75a of the registered image display field 75. The registered image display field 75 also has a ‘Registration Cancel’ button 75b to cancel registration of an image selected in the image display field 75a and an ‘All Registration Cancel’ button 75c to cancel registration of all registered images. The image registration dialog box 72 also has a Next’ button 72a to terminate the image registration step and to go to a next step in the print job creation process and a ‘Back’ button 72b to go back to a previous step in the print job creation process. A click of the ‘Back’ button 72b in the image registration window 70 terminates the image registration step and reopens the menu window 60. The ‘Back’ button 72b accordingly has the same function as that of the ‘Back to Menu’ button 71f. The image registration management module 22 of the print job creation apparatus 20 manages this image registration step.

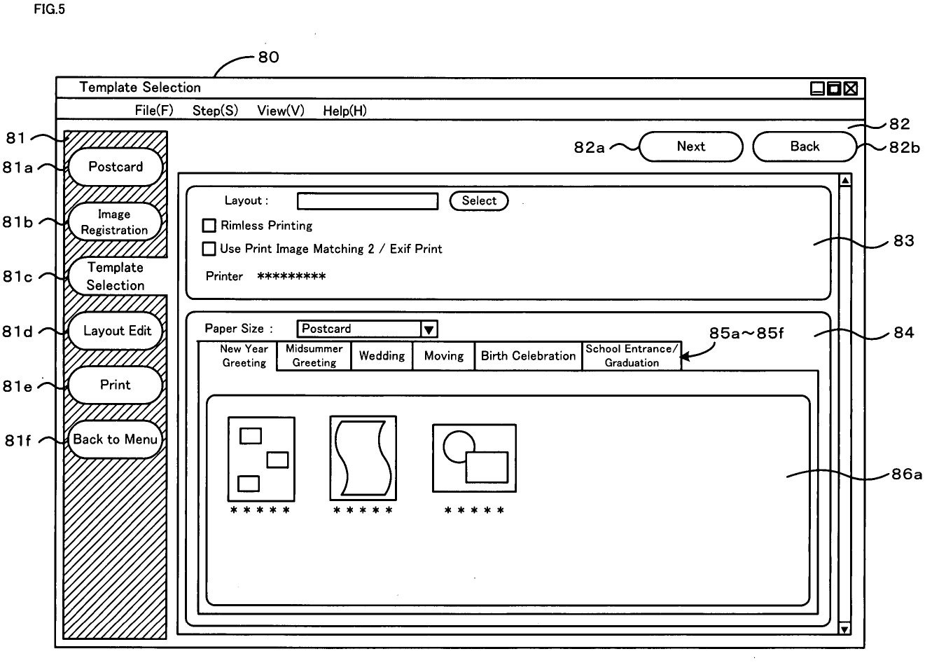

In response to a click of the ‘Next’ button 72a after registration of one or multiple desired images, the print job creation routine opens a template selection window 80 shown in FIG. 5 and executes a template selection step to select a desired template, in which the registered image is inserted (step S120). In the illustrated example of FIG. 5, the template selection window 80 includes a process display field 81, which is identical with the process display field 71 of the image registration window 70 shown in FIG. 4, and a template selection dialog box 82 to select a desired template. In this template selection window 80, the template selection dialog box 82 is displayed in connection with a ‘Template Selection’ button 81c in the process display field 81 and is open when the print job creation process is at the template selection step.

The template selection dialog box 82 has a setting field 83 to specify settings of a template and a template selection field 84 to select a desired template. The setting field 83 includes a layout input box for direct entry of a layout used as a template, a checkbox to set rimless printing, and a checkbox to effectuate image matching of a digital camera with a printer using ‘Print Image Matching 2’ and ‘Exif Print’. The template selection field 84 has tags 85a through 85f corresponding to available template types. The respective tags 85a through 85f have template display fields 86a through 86f to display a list of thumbnails and file names of available templates. The user selects a desired tag among the tags 85a through 85f and selects a desired template among templates displayed in the template display field of the selected tag. In response to selection of the desired template, the selected file name is shown in the layout input box of the setting field 83. The template selection field 84 also has a paper size input box to select a desired paper size. The template selection dialog box 82 has a ‘Next’ button 82a to go to a next step and a ‘Back’ button 82b to go back to a previous step, like the image registration dialog box 72. A click of the ‘Back’ button 82b in the template selection window 80 reopens the image registration window 70, and the processing goes back to the previous step, that is, the image registration step (step S110) in the print job creation process. The template setting management module 23 of the print job creation apparatus 20 manages this template selection process.

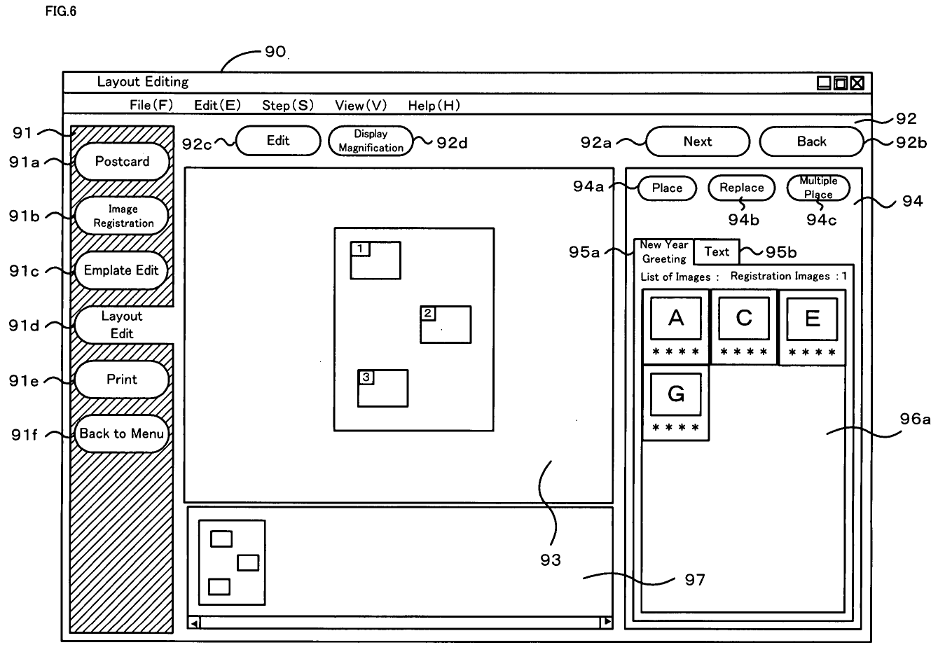

In response to a click of the ‘Next’ button 82a after selection of the desired template, the print job creation routine opens a layout editing window 90 shown in FIG. 6 and executes a layout editing step to adjust a layout of images and edit the images (step S130). In the illustrated example of FIG. 6, the layout editing window 90 includes a process display field 91, which is identical with the process display fields 71 and 81 in the image registration window 70 of FIG. 4 and in the template selection window 80 of FIG. 5, and a layout editing dialog box 92 to layout and edit the images. In this layout editing window 90, the layout editing dialog box 92 is displayed in connection with a ‘Layout Edit’ button 91d in the process display field 91 and is open when the print job creation process is at the layout editing step.

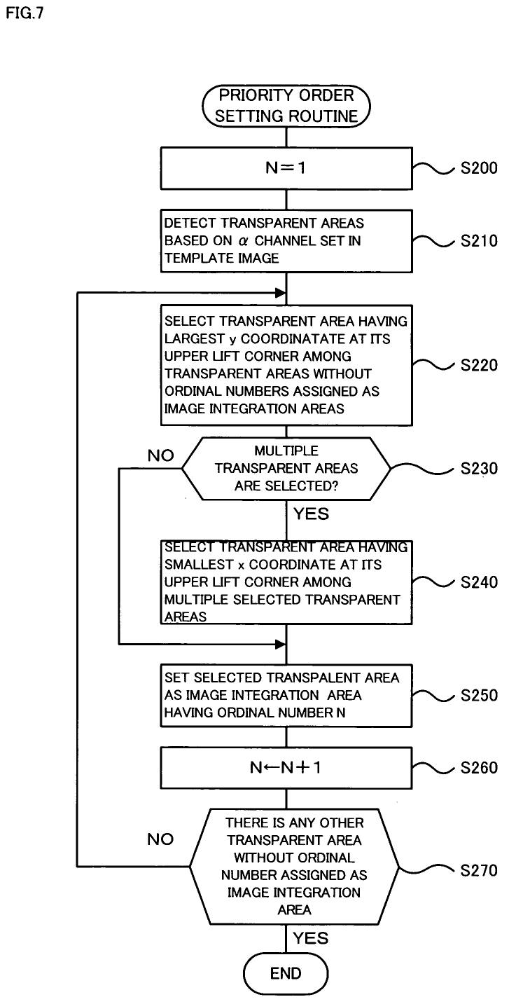

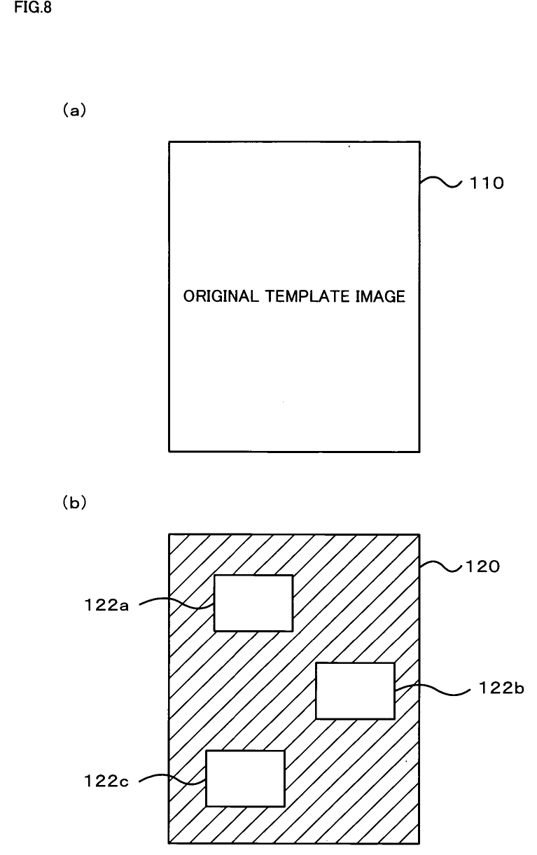

The layout editing dialog box 92 includes a layout editing field 93 to combine a selected template with registered images and thereby layout and edit the images, an image selection field 94 to select images to be combined with the selected template, and a thumbnail display field 97 to display the thumbnail of the selected template. A template selected on the template selection window 80 is shown in the layout editing field 93. Ordinal numbers are assigned to image integration areas included in the selected template from the top and from the left and are shown in the corresponding image integration areas in the layout editing field 93 as shown in FIG. 6. The priority order of the image integration areas is set according to a priority order setting routine shown in the flowchart of FIG. 7. The priority order setting routine first sets an initial value ‘1’ to a variable N (step S200) and detects transparent areas based on the α channel set in a template image (step S210). The template image is prepared by combining an original template image 110 with a one-pixel-one-bit mask image 120 having one-bit information for each one pixel to set transparent areas 122a through 122c in the original template image 110, as shown in FIG. 8. Namely the template image is obtained by setting the α channel in areas of the original template image 110 corresponding to the transparent areas 122a through 122c of the mask image 120 as completely transparent areas. In this embodiment, the transparent areas 122a through 122c of the mask image 120 are set as bit-off (white), whereas the residual areas are set as bit-on (black). Detection of the transparent areas in the template image thus specifies image integration areas. After detection of the transparent areas, the priority order setting routine selects a transparent area having a largest y coordinate value at its upper left corner (that is, a transparent area located at the top most position), among transparent areas without ordinal numbers assigned as image integration areas (step S220). When there are multiple transparent areas meeting this condition (step S230), a transparent area having a smallest x coordinate value at its upper left corner (that is, a transparent area located at the left most position) is selected, among the multiple transparent areas meeting the above condition (step S240). The priority order setting routine sets the selected transparent area as an image integration area having an ordinal number ‘N’ (step S250) and increments the variable N by one (step S260). The routine determines whether there is any other transparent area without an ordinal number assigned as an image integration area (step S270). When there is any transparent area without an ordinal number, the program goes back to step S220 and subsequent steps to select a transparent area and assign an ordinal number to the selected transparent area. When there is no transparent area without an ordinal number, on the other hand, the priority order setting routine is terminated. According to this processing routine, the higher priority order is given to the image integration area having the coordinate of its upper left corner at the more-upper position and the more-left position in the template. The priority order setting unit 24a of the layout editing management module 24 manages the process of setting the priority order of the image integration areas.

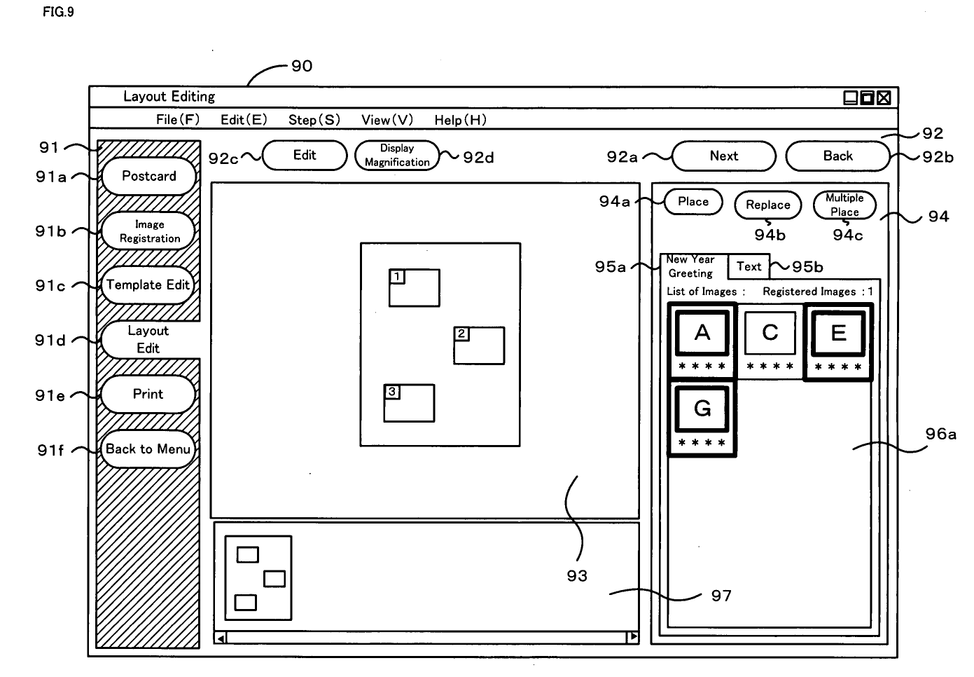

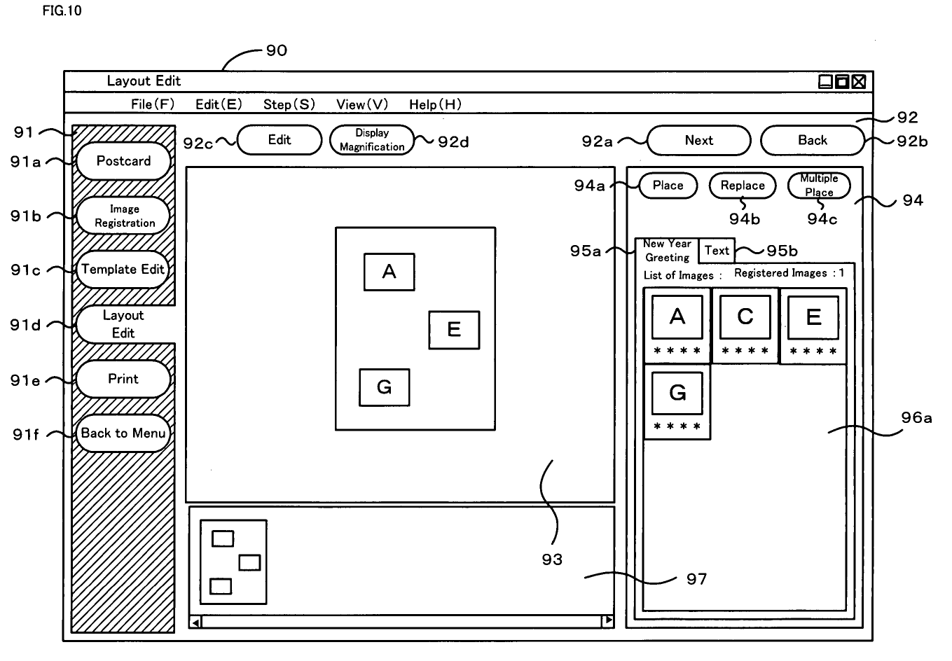

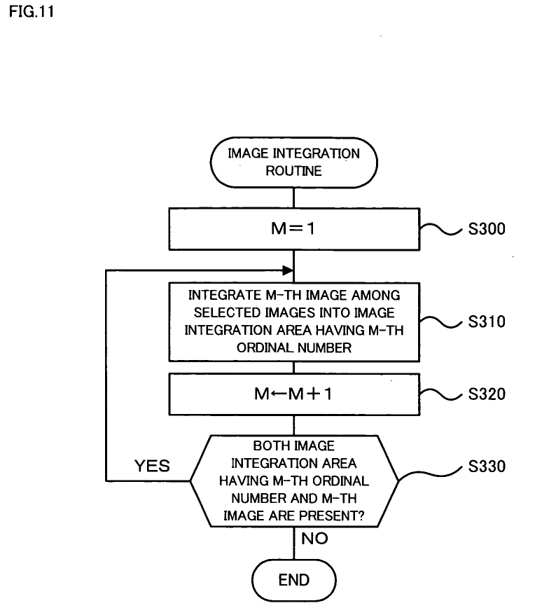

In the layout editing window 90, the image selection field 94 has a tag 95a for selecting one or multiple desired images among the registered images and a tag 95b for writing a text. The tag 95a has an image display field 96a to display a list of registered images and their file names. The tag 95b has a text input box for entry of a desired text, although not being specifically illustrated. The image selection field 94 also has a ‘Place’ button 94a to place each selected image in the template displayed in the layout editing field 93, a ‘Replace’ button 94b to replace a selected image with an image currently placed in the template in the layout editing field 93, and a ‘Multiple Place’ button 94c to place a selected image in multiple image integration areas of the template. The user selects one or multiple desired images among the registered images displayed in the image display field 96a and clicks the ‘Place’ button 94a or the ‘Multiple Place’ button 94c to locate the selected images in the template. In an illustrated example of FIG. 9, the user selects images ‘A’, ‘E’, and ‘G’ among the registered images displayed in the image display field 96a and clicks the ‘Place’ button 94a. The selected images are then integrated in their alignment order in the image display field 96a into the image integration areas of the template in the preset priority order. In the illustrated example of FIG. 9, the selected images are aligned in the order of ‘A’, ‘E’, and ‘G’ in the image display field 96a. The images ‘A’, ‘E’, and ‘G’ are accordingly integrated in this order into the image integration areas having the ordinal numbers ‘1’, ‘2’, and ‘3’. The resulting state after integration of the selected images into the image integration areas is shown in FIG. 10. This procedure follows an image integration routine shown in the flowchart of FIG. 11. The image integration routine first sets an initial value ‘1’ to a variable M (step S300), and integrates an M-th image among selected images into an image integration area having an M-th ordinal number (step S310). The routine then increments the variable M by one (step S320), and determines whether there is an image integration area having an incremented M-th ordinal number and whether there is an incremented M-th image among the selected images (step S330). When both the image integration area having the M-th ordinal number and the M-th image are present, the routine goes back to step S310 and subsequent steps to integarte the M-th image into the image integration area having the M-th ordinal number. When either the image integration area having the M-th ordinal number or the M-th image is absent, the image integration routine is terminated. This series of processing integrates the selected images in their alignment order into the image integration areas in the preset priority order. As clearly understood from the above description, when the number of the image integration areas is greater than the number of the selected images, the processing is terminated after sequentially integrating all the selected images into the image integration areas. When the number of the selected images is greater than the number of the image integration areas, on the other hand, the processing is terminated after filling all the image integration areas with the selected images integrated in their alignment order. The integration process unit 24b of the layout editing management module 24 manages this image integration process.

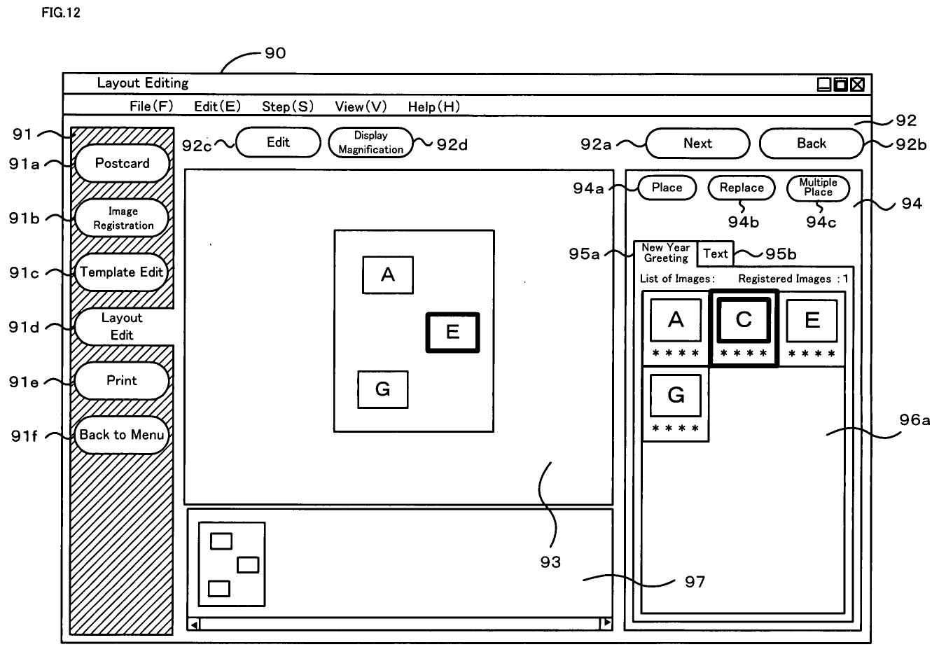

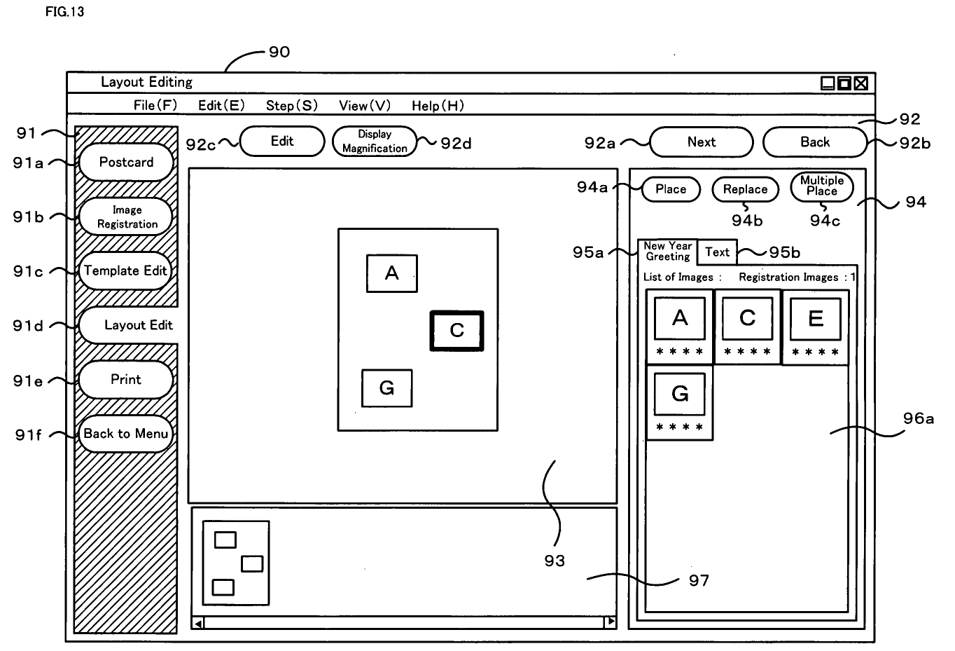

In order to attain replacement of an image currently placed in an image integration area of the template, the user selects an object image integration area for image replacement among the image integration areas of the template displayed in the layout editing field 93 and an object image to be integrated into the selected image integration area of the template among the images displayed in the image display field 96a and clicks the ‘Replace’ button 94b. In an illustrated example of FIG. 12, the user selects an object image integration area with an image ‘E’ currently placed therein among the image integration areas of the template displayed in the layout editing field 93, selects an object image ‘C’ among the images displayed in the image display field 96a, and clicks the ‘Replace’ button 94b. The object image ‘C’ then replaces the image ‘E’ currently placed in the selected object image integration area on the template as shown in FIG. 13. This process enables a desired image to replace an image currently placed in a selected image integration area of the template. The replacement process unit 24c of the layout editing management module 24 manages this image replacement process.

The user selects a desired image among the images displayed in the image display field 96a of the tag 95a and clicks the ‘Multiple Place’ button 94c. This integrates the selected image into the multiple image integration areas of the template.

The layout editing dialog box 92 has a ‘Next’ button 92a to go to a next step and a ‘Back’ button 92b to go back to a previous step, like the image registration window 70 and the template selection window 80. The layout editing dialog box 92 also has an ‘Edit’ button 92c to edit each image combined with the template displayed in the layout editing field 93 and a ‘Display Magnification’ button 92d to change a display magnification in the layout editing field 93. When the user selects an image combined with the template displayed in the layout editing field 93 and clicks the ‘Edit’ button 92c, a pulldown menu is open to select a desired specification of editing among various options including rotation, frame rotation, vertical or horizontal inversion, trimming, die cutting, contour softening/sharpening, settings of lightness and contrast, color change, change to sepia/monochromatic, cross filter, red eye reduction, cloning, and auto correction. The editing process unit 24d of the layout editing management module 24 of the print job creation apparatus 20 manages this image layout and editing process.

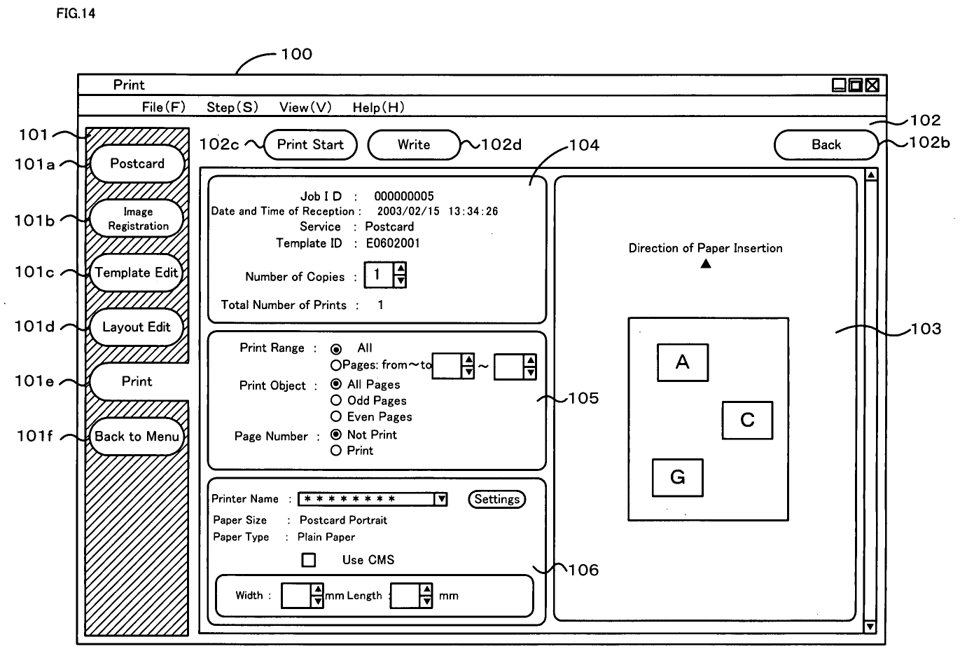

In response to a click of the ‘Next’ button 92a after layout of selected images in a selected template and desired editing in the layout editing window 90, the print job creation routine opens a print window 100 shown in FIG. 14 and executes a print step to specify various settings for printing and execute printing (step S140). In the illustrated example of FIG. 14, the print window 100 includes a process display field 101, which is identical with the process display fields 71, 81, and 91 of the image registration window 70, the template selection window 80, and the layout editing window 90, and a print dialog box 102 to specify settings for printing and give a print execution instruction. In this print window 100, the print dialog box 102 is displayed in connection with a ‘Print’ button 101e in the process display field 101 and is open when the print job creation process is at the print step.

The print dialog box 102 has a printed image display field 103 to display a resulting image to be printed, which has been set in the template and gone through layout and editing, a job information display field 104 to display information regarding a current print job, a printing condition setting field 105 to set printing conditions, and a printer setting field 106 to specify settings of a printer. The job information display field 104 shows the job ID, the date and time of reception, the service, and the template ID as information regarding the current print job, and has a copy number input box to selectively enter a desired number of copies. The printing condition setting field 105 has radio buttons and an input box for setting a print range, radio buttons for setting a print object, and radio buttons for selecting either printing or non-printing of page numbers. The printer setting field 106 has a printer selection box to select a printer to be used for printing, a check box to select either application or non-application of color management system (CMS), and an area input box for setting a printing area. The printer setting field 106 also shows the settings of the paper size and the paper type in the selected printer. The printer selection box in the printer setting field 106 initially shows a printer set in advance corresponding to a selected combination of print service and paper size as environment settings as a default printer. The print dialog box 102 also has a ‘Back’ button 102b to go back to a previous step, a ‘Print Start’ button 102c to give a print execution instruction, and a ‘Write’ button 102d to write a resulting image file into a desired directory or folder, instead of printing. The print job creation process executed by the print job creation apparatus 20 of the embodiment terminates in response to a click of the ‘Print Start’ button 102c or in response to a click of the ‘Write’ button 102d. A click of the ‘Print Start’ button 102c or the ‘Write’ button 102d starts execution of the created print job. After execution of printing with the selected printer in response to a click of the ‘Print Start’ button 102c or writing an image file in response to a click of the ‘Write’ button 102d, the display returns to the menu window 60 for selection of another print service. The print job creation routine of FIG. 3 terminates at this stage. The print management module 25 of the print job creation apparatus 20 of the embodiment manages this printing-related step.

As described above, the print job creation apparatus 20 of the embodiment automatically sets the priority order of image integration areas in a selected template and displays the setting of the priority order. Selected images are then integrated in their alignment order into the image integration areas of the template in the preset priority order. The user is thus well notified of the combination of each selected image with an image integration area and is allowed to readily integrate all the selected images into the image integration areas. The print job creation apparatus 20 of the embodiment also enables to the user to readily replace an image currently placed in an image integration area of the template with a desired image.

The print job creation apparatus 20 of the embodiment detects transparent areas of a template image and sets the priority order of image integration areas in the corresponding template according to the locations of the detected transparent areas. One possible modification may detect the transparent areas 122a through 122c of the mask image 120 in the course of image processing and set the priority order of image integration areas in the corresponding template according to the locations of the detected transparent areas 122a through 122c. The transparent areas 122a through 122c are readily detectable, since the mask image 120 is a one-pixel-one-bit image having one-bit information for each one pixel.

The print job creation apparatus 20 of the embodiment sets the priority order of the image integration areas in the template, such that the higher priority order is given to the more-upper position and to the more-left position. This setting method is, however, not restrictive at all. The priority order may be set according to any reasonable rule.

The print job creation apparatus 20 of the embodiment sets the priority order of image integration areas in a selected template when the selected template is displayed in the layout editing field 93 of the layout editing window 90. The priority order of image integration areas may otherwise be set when a resulting template is registered into the print job creation apparatus 20. In the latter case, the priority order setting unit 24a is excluded from the management objects of the layout editing management module 24.

The print job creation apparatus 20 of the embodiment integrates the selected images in their alignment order into the image integration areas of the selected template in the preset priority order. The alignment order is, however, not restrictive in any sense. For example, the selected images may be integrated in the order of selection or in any other appropriate order into the image integration areas.

The print job creation apparatus 20 of the embodiment enables the user to select a desired print service among the various options, enlargement, digest printing, calendar printing, idea printing, postcard, photo name card, ID photo, index printing, seal printing, and label printing, on the menu window 60. These options of print services are only illustrative and not restrictive in any sense. Part of these print service options may be specified as selectable, or any print service options different from these options may be specified as selectable. These options may otherwise be combined with other print service options.

The print job creation apparatus 20 of the embodiment provides the album services and the CD writing services, in addition to the print services. The album services or the CD writing services may be omitted, when not required. The CD writing services may be replaced by writing services into other storage media, for example, flexible disks, MDs, DVDs, and flash memories.

The print job creation apparatus 20 of the embodiment displays the status, the job ID, the selected service, the time of reception, the time of update, the paper size, the number of copies, the total number of prints, and the comment as the information regarding the print job under creation in the job list field 62. Display of all these pieces of information is only illustrative and is not restrictive in any sense. Part of these pieces of information may be displayed selectively, or any other pieces of information may be displayed instead. The display may otherwise include these pieces of information in combination with other pieces of information.

In the print job creation apparatus 20 of the embodiment, the print job creation process has the four steps, the image registration step, the template selection step, the layout editing step, and the print step, subsequent to selection of a desired print service. This flow of the print job creation process is not restrictive in any sense and may be modified in various ways.

The above description regards the details of the print job creation apparatus 20 and the details of the printing system 10 including the print job creation apparatus 20 as the embodiment of the invention. Other possible applications of the invention include a method of creating a print job with the print job creation apparatus 20 (print job creation method), a program that causes the computer to function as the print job creation apparatus 20, and a program that causes the computer to execute the respective steps of the print job creation method. In the applications of these programs, the respective steps in the print job creation routine of FIG. 3, those in the priority order setting routine of FIG. 7, and those in the image integration routine of FIG. 11 are programmed in an appropriate programming language.

The above embodiments are to be considered in all aspects as illustrative and not restrictive. There may be many modifications, changes, and alterations without departing from the scope or sprit of the main characteristics of the present invention. All changes within the meaning and range of equivalency of the claims are therefore intended to be embraced therein.

1. A print job creation apparatus that creates a print job, which includes layout of at least one image in a template having at least one image integration area to integrate an image therein, said print job creation apparatus comprising:
a template selection module that selects a template in response to a user's template selection instruction;
a priority order setting module that sets a priority order of at least one image integration area included in the selected template, based on an arrangement of the at least one image integration area;
a built-in image selection module that selects at least one image as a built-in image to be integrated into the selected template, in response to the user's image selection instruction; and
an image integration module that integrates the at least one selected built-in image into the at least one image integration area of the selected template in the priority order set by said priority order setting module, in response to the user's image integration instruction.

2. A print job creation apparatus in accordance with claim 1, wherein said priority order setting module sets the priority order of the at least one image integration area according to a positional sequence of an upper end of each image integration area in the selected template.

3. A print job creation apparatus in accordance with claim 1, wherein said priority order setting module sets the priority order of the at least one image integration area according to a positional sequence of a left end of each image integration area in the selected template.

4. A print job creation apparatus in accordance with claim 1, wherein the template is prepared by setting at least one transparent area as the image integration area in an original template image, which has no image integration area, and
said priority order setting module sets the priority order of the at least one image integration area, based on an arrangement of the at least one transparent area in the original template image.

5. A print job creation apparatus in accordance with claim 1, wherein the template is prepared by combining an original template image, which has no image integration area, with at least one area display image, which defines the at least one image integration area, and
said priority order setting module sets the priority order of the at least one image integration area, based on the at least one area display image.

6. A print job creation apparatus in accordance with claim 5, wherein the area display image is used to set a transparent area corresponding to the image integration area in the original template image.

7. A print job creation apparatus in accordance with claim 5, wherein the area display image is a one-pixel-one-bit image having one-bit information for each one pixel, which represents either a bit-on or a bit-off to show inclusion into or exclusion from an image integration area.

8. A print job creation apparatus in accordance with claim 1, said print job creation apparatus further comprising:
an image replacement module that, in response to the user's selection of one image integration area in the template with a built-in image currently placed therein by said image integration module and an image to be newly integrated into the selected image integration area, replaces the built-in image currently placed in the selected image integration area with the selected image.

9. A print job creation apparatus in accordance with claim 1, said print job creation apparatus further comprising:
a print service selection module that selects one print service among multiple print service options, in response to the user's operation; and
a template storage module that stores available templates corresponding to each of the multiple print service options,
wherein said template selection module displays a list of available templates corresponding to a print service selected by said print service selection module, among all the templates stored in said template storage module, to allow selection of a desired template.

10. A print job creation apparatus in accordance with claim 9, wherein the multiple print services include at least one of an enlargement printing service, a digest printing service, a calendar printing service, a postcard printing service, a photo name card printing service, an ID photograph printing service, a seal printing service, a label printing service, and an album printing service.

11. A print job creation method that creates a print job, which includes layout of at least one image in a template having at least one image integration area to integrate an image therein, said print job creation method comprising the steps of:
(a) selecting a template in response to a user's template selection instruction;
(b) setting a priority order of at least one image integration area included in the selected template, based on an arrangement of the at least one image integration area;
(c) selecting at least one image as a built-in image to be integrated into the selected template, in response to the user's image selection instruction; and
(d) integrating the at least one selected built-in image into the at least one image integration area of the selected template in the priority order set in said step (b), in response to the user's image integration instruction.

12. A print job creation method in accordance with claim 11, wherein said step (b) sets the priority order of the at least one image integration area according to a positional sequence of an upper end and a positional sequence of a left end of each image integration area in the selected template.

13. A print job creation method in accordance with claim 11, said print job creation method further comprising the step of:
in response to the user's selection of one image integration area in the template with a built-in image currently placed therein in said step (d) and an image to be newly integrated into the selected image integration area, replacing the built-in image currently placed in the selected image integration area with the selected image.
